(19) United States
(12) Patent Application Publication
(10) Pub. No.: US 2004/0147271 A1
(43) Pub. Date: Jul. 29, 2004

(54) Method of paging mobile stations, and equipment for implementing that method

(75) Inventors: Thierry Billon, Puteaux (FR); Christophe Gruet, Montigny Le Bretonneux (FR)

Correspondence Address: PIPER RUDNICK, P. O. BOX 64807, CHICAGO, IL, 60664-0807, US

(73) Assignee: NORTEL NETWORKS LIMITED

(21) Appl. No.: 10/739,727

(22) Filed: Dec. 17, 2003

(30) Foreign Application Priority Data
Dec. 27, 2002 (FR) FR 02 16811

(51) Int. Cl. H04Q 7/20

(52) U.S. Cl. 455/458

(57) ABSTRACT

An infrastructure of a radiocommunication network transmits mobile station paging messages. Each paging message transmitted is preceded by a paging indication message comprising paging indication information identifying a mobile station intended to receive a request contained in the paging message. The paging indication message further comprises a repetition indication field to indicate whether the paging message contains at least one request already contained in a previously transmitted paging message.

### BACKGROUND OF THE INVENTION

The present invention relates to mobile radio communications and more particularly to procedures for paging mobile stations. It finds application especially in third generation networks of the UMTS type (“Universal Mobile Telecommunication System”), the architecture of which is shown in FIG. 1.

The switches of the mobile service 10, belonging to a core network (CN), are linked to one or more fixed networks 11 and, by means of an interface known as Iu, to control equipment 12, or RNC (“Radio Network Controller”). Each RNC 12 is linked to one or more base stations 9 by means of an interface known as Iub. The base stations 9, spread over the network's coverage territory, are capable of communicating by radio with the mobile terminals 14, 14a, 14b called UE (“User Equipment”). The base stations 9, also called “node B”, can each serve one or more cells by means of respective transceivers 13. Certain RNCs 12 can also communicate with one another by means of an interface known as Iur. The RNCs and the base stations form an access network called UTRAN (“UMTS Terrestrial Radio Access Network”).

In cellular radiocommunication networks, the location of each mobile station uses the geographic area concept, each geographic area being capable of comprising several radioelectric cells. To locate a mobile station in order, for example, to initiate a call to that station, the network infrastructure uses a procedure known as “paging” the selected station. For this it transmits in particular paging messages over a paging channel in each cell of the geographic location area. Such paging messages contain one or more requests each intended for a mobile station which the infrastructure seeks to reach. Usually, these paging requests are repeated in successive messages until the mobile stations concerned respond to them, in order to improve the reliability of the procedure.

The UMTS system comprises a discontinuous reception mode (DRX) aimed at minimizing the mobiles' consumption to increase their battery life. This discontinuous reception mode is associated with the paging of mobile stations. Mechanisms for forming groups of mobile stations according to their identity, and the parameter setting of discontinuous reception cycles, are thus described in technical specification 3G TS 25.304 (“UE Procedures in Idle Mode and Procedures for Cell Reselection in Connected Mode”), version 3.9.0, published by the 3GPP (“3rd Generation Partnership Project”) in December 2001. Time recurrences (“paging occasions”) are thus created for each of the groups, so that the mobiles belonging to a group have to listen only at times corresponding to the transmission of paging messages for their group.

The UMTS system also provides for a “paging indication” mechanism to improve the effectiveness of the DRX mode. Prior to the transmission of paging messages in a group, paging indications are transmitted, the coding of which is used to distinguish between the sub-groups in the group. The number of sub-groups in a group is a system parameter, so that there can be Np=18, 36, 72 or 144 sub-groups in a group. The paging indications for each sub-group are transmitted over a physical channel called PICH (“Paging Indicator Channel”).

So, a mobile station listens constantly to the paging indicators corresponding to the sub-group to which it belongs. When it detects a paging indication corresponding to its sub-group, it will decode the corresponding paging message.

The paging procedure, as we have seen, assumes the transmission over a geographic area of paging messages likely to be repeated if the mobiles for which they are intended do not respond to them. It therefore implies a load on the radio interface, as large as the location area in question is extensive, due in particular to the transmission of paging messages in the cells of the area under the coverage of which the paged mobiles are not found. The repetition of the paging messages increases the load generated by this procedure, the more so when it is systematic.

In addition, the constant listening and systematic decoding of the paging indicators and the decoding of the corresponding paging messages by a mobile station contributes to its electrical consumption, to the detriment of its battery life.

An object of the present invention is to optimize the paging procedure with a view to reducing the consumption of the mobile stations.

Another object of the present invention is to optimize the paging procedure with a view to reducing the load on the radio resources allocated to it.

### SUMMARY OF THE INVENTION

The invention thus proposes a method of paging, via an infrastructure of a radiocommunication network, mobile stations in a group of mobile stations subdivided into sub-groups. The infrastructure transmits paging messages for mobile stations in the group in paging cycles repeated according to a time recurrence scheme, each active paging message containing at least one request intended for a respective mobile station. Each paging message transmitted for at least one mobile station in the group is preceded by a paging indication message comprising paging indication information for each sub-group including at least one mobile station intended to receive a request contained in said paging message. The paging indication message further comprises a repetition indication field to indicate whether said paging message contains at least one request already contained in a previously transmitted paging message.

In a preferred embodiment, the repetition indication field is activated only when, if a paging indication is to be activated to page a mobile station in a sub-group, no paging indication has been activated to page another mobile station belonging to the same sub-group during a predetermined number (N) of previous successive paging cycles. The repetition indication field is then preferably encoded by a Boolean variable.

In a second embodiment of the invention, the repetition indication field comprises a plurality of sections, each section corresponding to a respective sub-group. Preferably, a section is then activated to indicate a repetition for the corresponding sub-group only when no paging indication has been activated to page a mobile station belonging to said sub-group during a predetermined number (N) of previous successive paging cycles, other than the station for which a paging indication has already been activated.

Another aspect of the invention relates to a fixed radiocommunication unit, such as base station or base station controller, for implementing such a paging method.

A fourth aspect of the invention relates to a radiocommunication mobile station, comprising transceiver means for communicating with an infrastructure of a radiocommunication network transmitting mobile station paging messages and paging indication messages constructed according to the above method, means for receiving said messages, means of analyzing the paging indication information and the repetition indication field included in said paging indication messages and means for controlling the reception means to interrupt reception of the paging messages in response to the information carried by the repetition indication field.

### BRIEF DESCRIPTION THE DRAWINGS

FIG. 1, previously discussed, is a schematic diagram of a UMTS network;

FIG. 2 is a diagram illustrating the downlink frame structure used in the UMTS system in FDD mode;

FIG. 3 is a diagram illustrating a PICH frame structure using a Boolean coding of the repetition field according to a first embodiment of the invention;

FIG. 4 is a diagram illustrating a PICH frame structure using a bitmap type coding of the repetition field according to a second embodiment of the invention;

FIG. 5 is a diagram illustrating a PICH frame structure using an absolute coding of the repetition field according to the second embodiment of the invention;

FIG. 6 is a schematic diagram of a radiocommunication mobile station according to the invention.

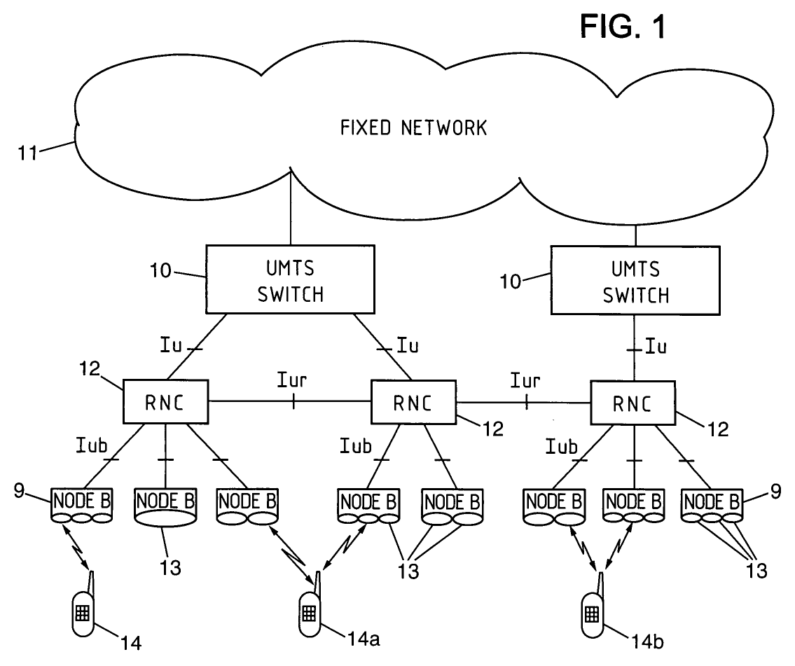

### DESCRIPTION OF PREFERRED EMBODIMENTS

The invention is described here in its non-limitative application to the radio access network of a cellular system of the UMTS type.

The UMTS is a radiocommunication system using code-division multiple access (CDMA), which means that the symbols transmitted are multiplied by spreading codes consisting of samples called “chips”, the rate of which (3.84 Mchip/s in the case of the UMTS) is higher than that of the symbols transmitted. The spreading codes distinguish different physical channels (PhCH) superimposed on the same transmission resource constituted by a carrier frequency. The auto- and cross-correlation properties of the spreading codes allow the receiver to separate the PhCHs and extract the symbols that are intended for it. For the UMTS in FDD mode on the downlink, a scrambling code is allocated to each base station and different physical channels used by that base station are distinguished by mutually orthogonal “channelization” codes. For each PhCH, the overall spreading code is the product of the “channelization” code and the scrambling code of the base station. The spreading factor (equal to the ratio between the chip rate and the symbol rate) is a power of 2 lying between 4 and 512. This factor is chosen according to the symbol bit rate to be transmitted over the PhCH.

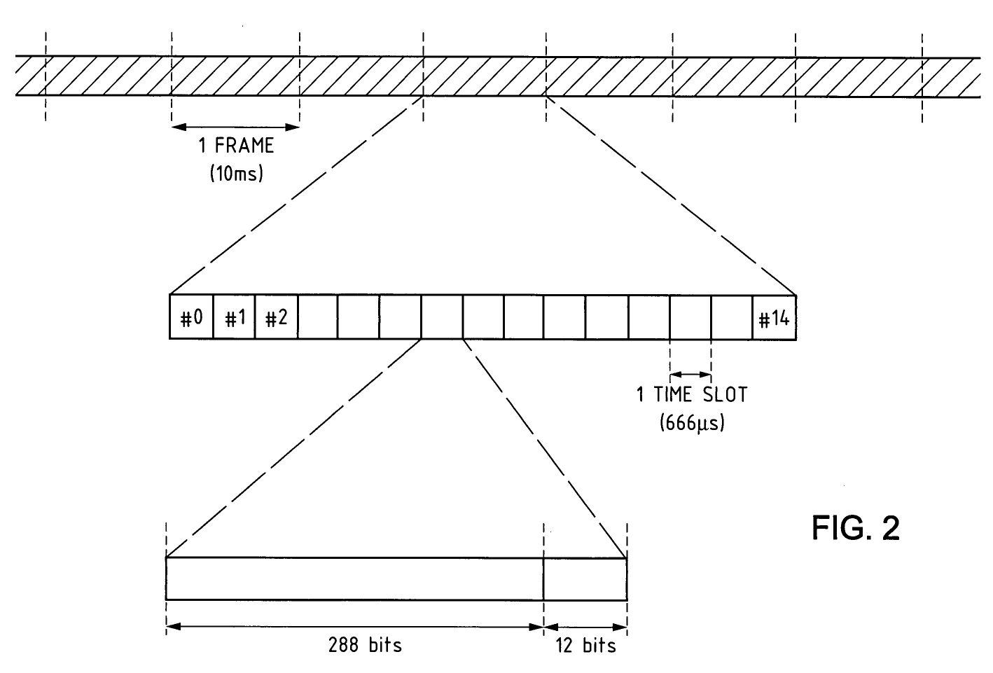

The different physical channels comply with a frame structure illustrated in FIG. 2. The 10 ms frames succeed one another on the carrier frequency used by the base station. Each frame is subdivided into 15 timeslots of 666 μs. Each slot can carry the superposed contributions of one or more physical channels, comprising common channels and dedicated physical channels (DPCH). The common channels comprise a common pilot channel (CPICH), primary common control physical channels (P-CCPCH) and secondary common control physical channels (S-CCPCH) as well as the paging indicator channel (PICH).

The S-CCPCH is employed in particular to carry paging channels (PCH) assigned to the paging of mobile stations.

The lower diagram in FIG. 2 illustrates the contribution of a PICH channel to a timeslot in FDD mode. This contribution comprises 288 bits for encoding Nₚ paging indicators, each corresponding to a sub-group (Nₚ=18, 36, 72 or 144). The position of a paging indicator relating to a sub-group over that set of 288 bits is not fixed. It is described in detail in paragraph 5.3.3.10 of technical specification 3G 25.211 (“Physical channels and mapping of transport channels onto physical channels (FDD)”), version 3.9.0, published in December 2001 by the 3GPP. The bits assigned to the encoding of a paging indicator are used in Boolean format so that they are all positioned at “1” when a paging indicator is active and at “0” if it is not. When a paging indicator is active, the UEs of the corresponding sub-group must go and read the corresponding frame of the associated S-CCPCH channel. A 12-bit field, positioned at the end of the PICH frame, is not used for specification purposes.

The time synchronization of the different physical channels is described in paragraph 7.1 of technical specification 3G TS 25.211. The time of occurrence of a PICH frame is τ_{PICH} prior to that of a S-CCPCH frame. In the preferred embodiment of the invention, the 12 unused bits of the PICH frame are used as a repetition indication field to indicate, where necessary, that an active paging indicator in the frame had already been activated on one or more of the N preceding paging cycles for the paging of a same mobile station.

A first embodiment of the invention uses a Boolean coding on these 12 bits. So, when an active paging indicator in the frame had already been activated on one or more of the previous N paging cycles for paging one and the same UE, these twelve bits are positioned at “1”, and at “0” in the contrary case. The use of Boolean coding requires that this repetition indication be positioned only when no activated paging indicator for the current frame has already been positioned during the previous N cycles, with the exception of the case where these multiple activations are intended for paging one and the same mobile station.

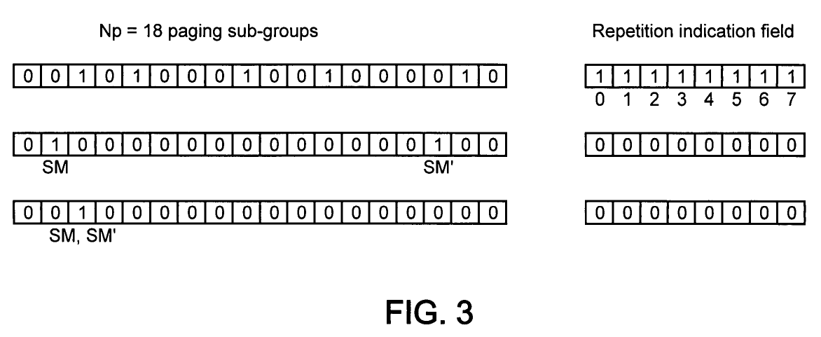

FIG. 3 illustrates this mode of repetition coding. In the illustrated example, the PICH frame comprises Nₚ=18 paging indicators. Five of them are active, three of which are active for a mobile station paging request which is repeated. None of the five active paging indicators corresponds to a new paging message for a station belonging to a sub-group the indicator of which has already been activated during the previous N cycles. The repetition indication field is then activated.

The second frame in FIG. 3 illustrates a case where it is desirable not to activate the repetition indication field despite the activation of paging indicators corresponding to repeated paging requests. In order of appearance in the frame, the indicators corresponding to sub-groups numbered 2 and 16 are active, to indicate that two mobile stations, SM and SM′, belonging to the sub-groups respectively associated with the indicators, are intended recipients of a paging request. The paging request for the SM′ station is repeated, whereas the paging request for the SM station is not. If we suppose that the SM station has received and then processed during the previous N paging cycles a paging request which was not intended for it on the basis of a paging indication for its sub-group, the activation of the repetition indication field would induce it to error. The activation of the repetition indication field would indeed lead it to consider that this new activation of the paging indicator of its sub-group corresponds to a repetition, which is not the case.

The third frame in FIG. 3 illustrates another similar case in which it is desirable not to activate the repetition indication field despite the activation of paging indicators corresponding to repeated paging requests. In order of appearance in the frame, the indicator corresponding to the sub-group numbered 3 is active to indicate that two mobile stations, SM and SM′, belonging to the sub-group respectively associated with the active indicator, are intended recipients of a paging request. The paging request for the SM′ station is repeated, whereas the paging request for the SM station is not. If we suppose that the SM station has received and then processed during the previous N paging cycles a paging request previously intended for the SM′ station, on the basis of a paging indication for its sub-group, the activation of the repetition indication field would induce it to error. The activation of the repetition indication field would indeed lead it to consider that this new activation of the paging indicator of its sub-group signals a repetition relating to it, which is not the case.

Another possibility consists in using in the repetition indication field a coding by sub-group on the 12 unused bits of the PICH frame to indicate that an active paging indicator in the frame had already been activated on one or more of the previous N paging cycles for paging one and the same UE. This coding is used to indicate that the frame does or does not comprise repetitions relating to each of the sub-groups. In this case, the repetition indication must, as appropriate, be positioned only for sub-groups for which the paging indicator has not been activated other than on the occasion of this repetition.

In a second embodiment of the invention, certain bits of the repetition indication field are encoded in this manner to indicate that the corresponding paging indicator is activated following the repetition of a paging message.

The structure of the paging messages of the UMTS system is described in paragraphs 10.2.20, 10.2.21 and 10.3.10 of technical specification 3G TS 25.331 (“Radio Resource Control (RRC) protocol specification”), version 3.9.0, published in December 2001 by the 3GPP. Only maxPage1=8 mobile stations at most can be recipients of a paging message, so that at most eight paging indicators can be simultaneously activated in a corresponding PICH frame. As a result, only eight bits of the repetition indication field are necessary to encode the repetitions which might occur. The other bits can for example be used to increase the reliability of transmission of the repetition indication bits, for example by means of a block code.

As previously indicated, the position of a paging indicator relating to a sub-group over all the first 288 bits of a PICH frame varies. The first eight bits of the repetition indication field may however constitute a “bitmap” in which the information carried by each bit relates to the active paging indicator of which the order of appearance amongst all the active paging indicators corresponds to the position of the bit in the repetition indication field. So, a respective sequence number for appearance in the PICH frame is associated with each active paging indicator, and the bit with the same sequence number is used in the repetition indication field to indicate any repetition.

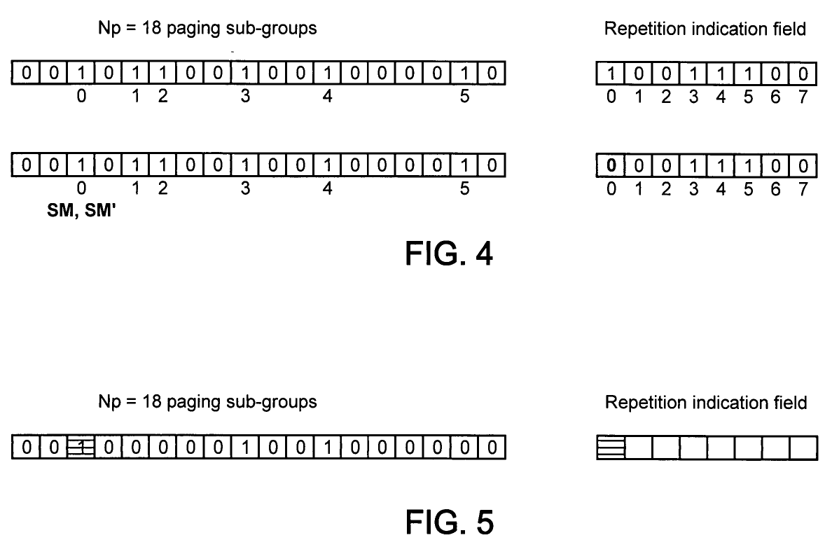

FIG. 4 illustrates this mode of repetition coding. In the example illustrated, the PICH frame comprises Nₚ=18 paging indicators. Six of them are active, four of which are active for a repeated mobile station paging request. A sequence number, which can be from 0 to 7, is associated with each active paging indicator and the repetition indication field indicates that the active indicators with sequence numbers 0, 3, 4 and 5 correspond to repetitions.

So, a mobile station which sees the paging indicator associated with its sub-group activated can determine that indicator's sequence number by decoding the indicators preceding the one associated with its sub-group and then decoding the bit with the corresponding sequence number in the repetition indication field.

The second frame in FIG. 4 illustrates a case where it is desirable not to activate the repetition indication field despite the activation of paging indicators corresponding to repeated paging requests. In order of appearance in the frame, the indicator corresponding to the sub-group with sequence number 3 is active to indicate that two mobile stations, SM and SM′, belonging to the sub-group respectively associated with the active indicator, are intended recipients of a paging request. The paging request for the SM′ station is repeated, whereas the paging request for the SM station is not. If we suppose that the SM station has received and then processed during the previous N paging cycles a paging request previously intended for the SM′ station, on the basis of a paging indication for its sub-group, the activation of the bit of the repetition indication field for the corresponding sub-group would induce it to error. It would indeed lead it to consider that this new activation of the paging indicator for its sub-group signals a repetition relating to it, which is not the case.

In a third embodiment of the invention, another scheme of encoding by sub-group is envisaged. This scheme has the advantage of making it possible to dispense with a partial decoding of the PICH frame so as to be able to exploit the information carried by the repetition indication field. It takes advantage of the code division multiple access scheme used in UMTS.

The PICH channel spreading factor is 256, so the 12 bits of the repetition indication field correspond to 12×256=3072 chips. As previously described, only a maximum of eight repetition indicators can be active in a PICH frame. The repetition information can therefore be encoded on 3072/8=384 chips for each of the sub-groups corresponding to these active repetition indicators.

According to this embodiment, the activation of a repetition indication is effected by partially copying the chip sequence used for the paging indicator to the repetition indication field. We can for example restrict ourselves to the first 384 chips of the sequence. The repetition indication field is then made up of 8 sequences of 384 chips which correspond, when they indicate a repetition, to the sequence of the first 384 chips of the corresponding paging indicator.

The aforesaid sequence is in effect unique to each of the indicators and therefore of the corresponding sub-groups, due to the auto- and cross-correlation properties of the scrambling code, the length of which very greatly exceeds the number of chips making up a PICH frame. Each paging indicator is encoded by means of a unique portion of the spreading code on a PICH frame. The mobile stations, which decode the paging indicator corresponding to their sub-group, will then read the repetition indication field so as to correlate the first 384 chips of their paging indicator with the 8 sequences of 384 chips contained in the repetition indication field. If a correlation is detected, the repetition indication is considered to be active.

FIG. 5 illustrates this mode of repetition coding. In the example illustrated, the PICH frame comprises Nₚ=18 paging indicators. Three of them are active, one of which is for a repeated mobile station paging request. The first 384 chips of the portion of the scrambling code encoding the paging indicator that corresponds to the repetition are copied at the beginning of the repetition indication field.

Advantageously, when the repetition indication field is distinct from the paging indication information, it precedes the latter, so that the mobile stations can exploit the repetition indication information without necessarily decoding all or some of the paging indication information.

In a fourth embodiment of the invention, we propose to modify the coding of the paging indicators as previously described and illustrated in Table I.

TABLE I

| HNₚ | Active indicator | Inactive indicator |
|---|---|---|
| 144 | {1, 1} | {0, 0} |
| 72 | {1, 1, 1, 1} | {0, 0, 0, 0} |
| 36 | {1, 1, 1, 1, 1, 1, 1, 1} | {0, 0, 0, 0, 0, 0, 0, 0} |
| 18 | {1, 1, 1, 1, 1, 1, 1, 1, 1, | {0, 0, 0, 0, 0, 0, 0, 0, 0, |
| | 1, 1, 1, 1, 1, 1, 1} | 0, 0, 0, 0, 0, 0, 0} |

The information transmitted over the PICH channel to notify that a paging indicator is active or not is binary, irrespective of the number of bits available for encoding each paging indicator. This number is equal to at least two, when Nₚ is selected to be equal to 144.

By adding a third state, the repetition information can be encoded right inside the paging indicators. The repetition indication field then coincides with the paging indication information field. An example of a third codeword is given in Table II:

TABLE II

| Nₚ | Repetition |
|---|---|
| 144 | {1, 0} |
| 72 | {1, 1, 1, 0} |
| 36 | {1, 1, 1, 1, 1, 1, 0, 0} |
| 18 | {1, 1, 1, 1, 1, 1, 1, 1, 1, 1, 1, 1, 0, 0, 0, 0} |

This additional codeword has the advantage of being sufficiently distant (for example according to a Hamming distance) from the word encoding an inactive indicator, while remaining close to the word encoding an active indicator. The most probable error would therefore lead to decoding an active indicator instead of a repetition indication, the only consequence of which would be the reading of a paging message that is identical to a message already received.

In a preferred embodiment of the invention, the paging procedure is implemented within the RNC 12. The RNC 12 has means of producing paging messages as described above. These messages are transmitted to the intended mobile stations via a radio resource control protocol described in technical specification 3G TS 25.331 (“Radio Resource Control (RRC) Protocol Specification”, version 3.9.0 published in December 2001 by the 3GPP). It also comprises means of communicating with the base stations having to send them repetition information to indicate whether a paging message contains at least one request already contained in a previously transmitted paging message. This repetition information, which can be constituted for each paging message, can be transmitted to the base stations concerned by means of the transceiver control application protocol, called the NBAP (“Node B Application Protocol”, see technical specification 3G TS 25.433, version 3.9.0, published in March 2002 by the 3GPP).

The Node-B or base stations 9 comprise means of formatting the PICH channels. These means are adapted according to the invention to encode the repetition indication fields or the paging indication information according to one of the methods described above. In a preferred embodiment of the invention, these means are arranged to include the repetition information based on the information transmitted by the RNC 12.

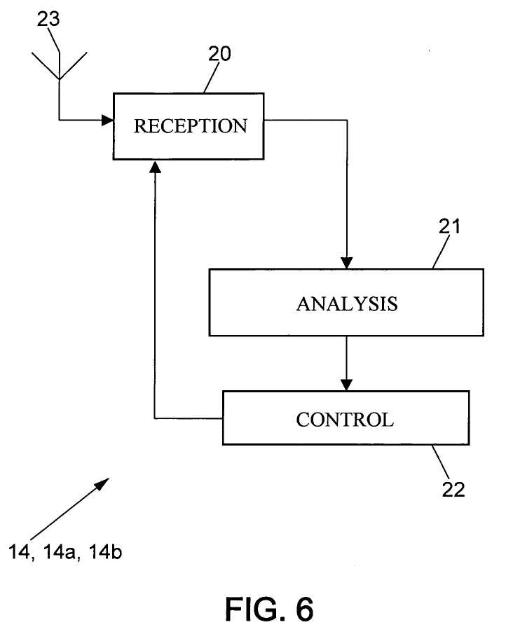

FIG. 6 illustrates the means used to implement the invention within a mobile station 14, 14a, 14b. The signals received via the receiving antenna 23 are processed within the reception unit 20 to extract from them the information carried by the channels that concern it. The unit 20 is arranged to receive and process the paging messages transmitted over the physical channel which carries the messages of the group to which the station 14, 14a, 14b belongs. It also monitors the PICH frames associated with the said S-CCPCH channel. Once extracted, the paging indication information is transmitted to an analysis module 21 which decodes, as appropriate, the repetition indication field by performing the dual operations of the encoding operations of this field according to one of the coding methods described above. A paging message reception control module 22 is provided to control the reception unit 20 in order to interrupt reception of the frames of the S-CCPCH channel when a paging message repetition is signaled to it.

The reception unit 20 can advantageously function according to a discontinuous reception mode (DRX) with a view in particular to prolonging the battery life of the mobile station 14, 14a, 14b.

1. A method of paging, via an infrastructure of a radiocommunication network, mobile stations in a group of mobile stations subdivided into sub-groups, comprising the steps of:
transmitting from the infrastructure paging messages for mobile stations in the group, in paging cycles repeated according to a time recurrence scheme, each active paging message containing at least one request intended for a respective mobile station; and
transmitting from the infrastructure, prior to each paging message transmitted for at least one mobile station in the group, a paging indication message comprising paging indication information for each sub-group including at least one mobile station intended to receive a request contained in said paging message, the paging indication message further comprising a repetition indication field to indicate whether said paging message contains at least one request already contained in a previously transmitted paging message.

2. The method as claimed in claim 1, wherein the repetition indication field precedes, in the paging indication message, the paging indication information.

3. The method as claimed in claim 1, wherein the repetition indication field is activated only when, if a paging indication is to be activated to page a mobile station in a sub-group, no paging indication has been activated to page another mobile station belonging to the same sub-group during a predetermined number of previous successive paging cycles.

4. The method as claimed in claim 3, wherein the repetition indication field is encoded by a Boolean variable.

5. The method as claimed in claim 1, wherein the repetition indication field comprises a plurality of sections each corresponding to a respective sub-group.

6. The method as claimed in claim 5, wherein a section is activated to indicate a repetition for the corresponding sub-group only when no paging indication has been activated to page a mobile station belonging to said sub-group during a predetermined number of previous successive paging cycles, other than the station for which a paging indication has already been activated.

7. The method as claimed in claim 5, wherein an activated section is positioned, in the repetition indication field, according to a sequence number of the corresponding sub-group amongst those of the sub-groups for which a paging indication is activated in the paging indication message.

8. The method as claimed in claim 5, wherein an activated section comprises part of the coding of the paging indication information of a sub-group for which a paging indication is activated in the paging indication message.

9. A fixed radiocommunication unit, comprising means for paging mobile stations in a group of mobile stations subdivided into sub-groups, wherein the paging means comprise:
means for controlling transmission of paging messages for mobile stations in the group, in paging cycles repeated according to a time recurrence scheme, each active paging message containing at least one request intended for a respective mobile station; and
means for controlling transmission, prior to each paging message transmitted for at least one mobile station in the group, of a paging indication message comprising paging indication information for each sub-group including at least one mobile station intended to receive a request contained in said paging message, the paging indication message further comprising a repetition indication field to indicate whether said paging message contains at least one request already contained in a previously transmitted paging message.

10. The unit as claimed in claim 9, wherein the repetition indication field precedes, in the paging indication message, the paging indication information.

11. The unit as claimed in claim 9, wherein the means for controlling transmission of the paging indication message are arranged to activate the repetition indication field only when, if a paging indication is to be activated to page a mobile station in a sub-group, no paging indication has been activated to page another mobile station belonging to the same sub-group during a predetermined number of previous successive paging cycles.

12. The unit as claimed in claim 11, wherein the repetition indication field is encoded by a Boolean variable.

13. The unit as claimed in claim 9, wherein the repetition indication field comprises a plurality of sections each corresponding to a respective sub-group.

14. The unit as claimed in claim 13, wherein the means for controlling transmission of the paging indication message are arranged to activate a section to indicate a repetition for the corresponding sub-group only when no paging indication has been activated to page a mobile station belonging to said sub-group during a predetermined number of previous successive paging cycles, other than the station for which a paging indication has already been activated.

15. The unit as claimed in claim 13, wherein an activated section is positioned, in the repetition indication field, according to a sequence number of the corresponding sub-group amongst those of the sub-groups for which a paging indication is activated in the paging indication message.

16. The unit as claimed in claim 13, wherein an activated section comprises part of the coding of the paging indication information of a sub-group for which a paging indication is activated in the paging indication message.

17. A radiocommunication mobile station, comprising:
transceiver means for communicating with an infrastructure of a radiocommunication network transmitting mobile station paging messages according to a time recurrence scheme and paging indication messages each preceding at least one of said paging messages, each active paging message containing at least one request intended for a recipient mobile station of a group of mobile stations subdivided into sub-groups;
means for receiving said messages;
means for analyzing paging indication information included in each paging indication message for each sub-group including at least one mobile station intended to receive a request contained in said paging message;
means for analyzing a repetition indication field included in said paging indication messages to indicate whether said paging message contains at least one request already contained in a previously transmitted paging message; and
means for controlling the reception means to interrupt reception of the paging messages in response to the information carried by the repetition indication field.

18. The mobile station as claimed in claim 17, wherein the means for receiving said messages have a discontinuous reception mode.
